(19) United States
(12) Patent Application Publication
(10) Pub. No.: US 2026/0205376 A1
(43) Pub. Date: Jul. 16, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Min LIU, Beijing (CN); Qin MU, Beijing (CN)

(21) Appl. No.: 19/137,964

(22) PCT Filed: Dec. 20, 2022
(86) PCT No.: PCT/CN2022/140500

§ 371 Date: Jun. 11, 2025

(51) Int. Cl. H04L 41/16; H04B 7/06

(52) U.S. Cl. CPC H04L 41/16; H04B 7/0639

(57) ABSTRACT

An information processing method is performed by user equipment (UE) and includes: exchanging a quantized dataset with a first network device, wherein the dataset is quantized based on a quantization capability of the UE, and the dataset is configured for at least one of training, optimization, or supervision of an artificial intelligence (Al) model.

### CROSS-REFERENCE TO RELATED APPLICATIONS

The present disclosure is a U.S. national phase of PCT Application No. PCT/CN2022/140500 filed on Dec. 20, 2022, the content of which is hereby incorporated by reference in its entirety.

### TECHNICAL FIELD

The present disclosure relates to, but is not limited to, a field of wireless communication technology, and in particular, to information processing methods, communication devices, and storage mediums.

### BACKGROUND

Training, fine-tuning, or supervision of artificial intelligence (AI) models may use various datasets. The fine-tuning of the model herein may also be referred to as model optimization or model optimizing.

Exemplary, transmission of the datasets is involved in the training, fine-tuning or supervision of the AI model.

A dataset exchanged between user equipment (UE) and a base station may be an original dataset or a compressed dataset. The UE may also be referred to as a terminal, a mobile station, a terminal device, or the like.

### SUMMARY

A first aspect of the embodiments of the present disclosure provides an information processing method. The method is performed by UE and includes: exchanging a quantized dataset with a first network device, where the dataset is quantized based on a quantization capability of the UE, and the dataset is configured for training, optimization, and/or supervision of an artificial intelligence (AI) model.

A second aspect of the embodiments of the present disclosure provides an information processing method. The method is performed by a first network device and includes: exchanging a quantized dataset with user equipment (UE), where the dataset is quantized based on a quantization capability of the UE, and the dataset is configured for training, optimization, and/or supervision of an artificial intelligence (AI) model.

A third aspect of the embodiments of the present disclosure provides a communication device, including a processor, a transceiver, and a memory storing a program executable by the processor, where the processor is configured to perform the information processing method provided in the first aspect or in the second aspect.

A fourth aspect of the embodiments of the present disclosure provides a computer storage medium storing an executable program, where the executable program is executed by a processor, the processor is caused to perform the information processing method provided in the first aspect or in the second aspect.

It should be understood that the above general description and the detailed description in the following text are only exemplary and explanatory, and cannot limit the embodiments of the present disclosure.

### BRIEF DESCRIPTION OF DRAWINGS

The accompanying drawings here are incorporated into the specification and form a part of this specification, show embodiments conforming to the present disclosure and are used together with the specification to explain principles of embodiments of the present disclosure.

FIG. 1 is a schematic structural diagram of a wireless communication system shown according to an exemplary embodiment.

FIG. 2A is a schematic flowchart of an information processing method shown according to an exemplary embodiment.

FIG. 2B is a schematic flowchart of an information processing method shown according to an exemplary embodiment.

FIG. 2C is a schematic flowchart of an information processing method shown according to an exemplary embodiment.

FIG. 2D is a schematic flowchart of an information processing method shown according to an exemplary embodiment.

FIG. 2E is a schematic flowchart of an information processing method shown according to an exemplary embodiment.

FIG. 2F is a schematic flowchart of an information processing method shown according to an exemplary embodiment.

FIG. 3A is a schematic flowchart of an information processing method shown according to an exemplary embodiment.

FIG. 3B is a schematic flowchart of an information processing method shown according to an exemplary embodiment.

FIG. 3C is a schematic flowchart of an information processing method shown according to an exemplary embodiment.

FIG. 3D is a schematic flowchart of an information processing method shown according to an exemplary embodiment.

FIG. 3E is a schematic flowchart of an information processing method shown according to an exemplary embodiment.

FIG. 3F is a schematic flowchart of an information processing method shown according to an exemplary embodiment.

FIG. 3G is a schematic flowchart of an information processing method shown according to an exemplary embodiment.

FIG. 4 is a schematic structural diagram of an information processing apparatus shown according to an exemplary embodiment.

FIG. 5 is a schematic structural diagram of an information processing apparatus shown according to an exemplary embodiment.

FIG. 6 is a schematic structural diagram of UE shown according to an exemplary embodiment.

FIG. 7 is a schematic structural diagram of a network device shown according to an exemplary embodiment.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. On the contrary, they are only examples of apparatuses and methods that are consistent with some aspects of embodiments of the present disclosure.

Terms used in the embodiments of the present disclosure are only for a purpose of describing specific embodiments, and are not intended to limit the embodiments of the present disclosure. Singular forms, “a/an,” “the,” and “this,” used in the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, the term “if” used herein may be interpreted as “when,” “while,” or “in response to determining.”

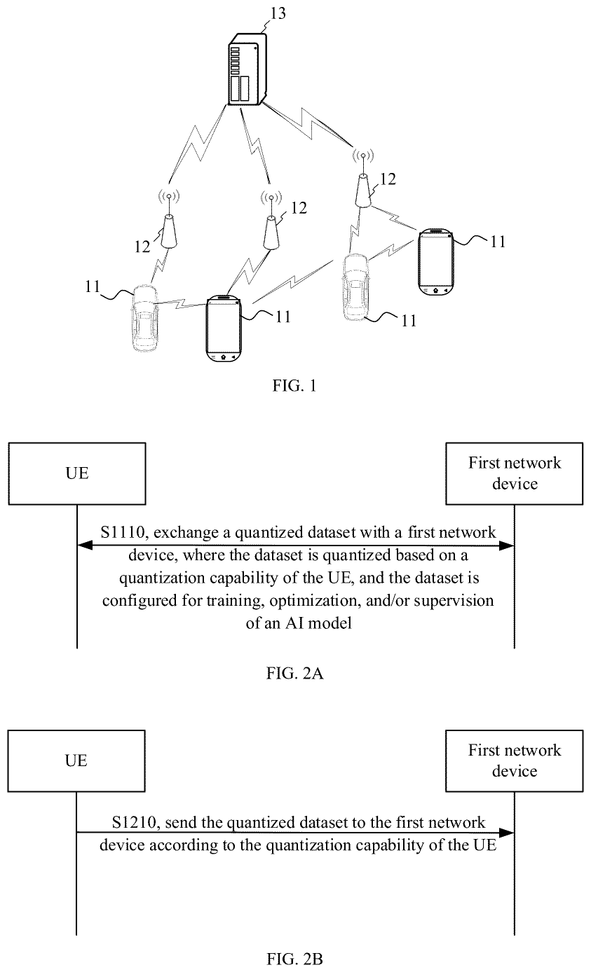

Referring to FIG. 1, FIG. 1 shows a schematic structural diagram of a wireless communication system provided by an embodiment of the present disclosure. As shown in FIG. 1, the wireless communication system is a cellular mobile communication technology-based communication system, and the wireless communication system may include several UE 11 and several network devices 12. The network device 12 may include an access device and/or a core network device.

The UE 11 may be a device that provides voice and/or data connectivity to a user. The UE 11 may communicate with one or more core networks through a radio access network (RAN). The UE 11 may be an Internet of Things terminal, such as a sensor device, a mobile phone (or referred to as a cellular phone), and a computer having the Internet of Things terminal, for example a fixed, portable, pocket, handheld, computer built-in, or vehicle-mounted apparatus. For example, the UE may be a station (STA), a subscriber unit, a subscriber station, a mobile station, a mobile table, a remote station, an access point, a remote terminal, an access terminal, a user terminal, a user agent, or a user device. Alternatively, the UE 11 may be a device of an unmanned aerial vehicle. Alternatively, the UE 11 may be a vehicle-mounted device, for example, a vehicle computer having a wireless communication function, or a wireless communication device externally connected to a vehicle computer. Alternatively, the UE 11 may also be a roadside device, for example, a street lamp, a signal light, other roadside device, etc., having a wireless communication function.

The network device 12 may be a network-side device in the wireless communication system. The wireless communication system may be a 4-th generation mobile communication (4G) system, also referred to as a long term evolution (LTE) system; or the wireless communication system may also be a 5G system, also referred to as a new radio (NR, or new air interface) system or a 5G NR system. Alternatively, the wireless communication system may be a next generation system of the 5G system. The access network in the 5G system may be referred to as an NG-RAN (new generation-radio access network). Alternatively, the wireless communication system may be an MTC (manual toll collection) system.

The access device may be an evolved access device (eNB) used in the 4G system. Alternatively, the access device may also be an access device (eNB) using a centralized distributed architecture in the 5G system. When the access device uses the centralized distributed architecture, the access device usually includes a central unit (CU) and at least two distributed units (DUs). The central unit is provided with a protocol stack of a packet data convergence protocol (PDCP) layer, a radio link control (RLC) layer, and a media access control (MAC) layer; and the distributed unit is provided with a protocol stack of a physical (PHY) layer. The specific implementation of the access device is not limited in the embodiment of the present disclosure.

A wireless connection may be established between the network device 12 and the UE 11 through a wireless air interface. In different implementations, the wireless air interface is a wireless air interface based on a 4-th generation mobile communication network technology (4G) standard; or the wireless air interface is a wireless air interface based on a 5-th generation mobile communication network technology (5G) standard, for example, the wireless air interface is a new radio; or the wireless air interface may also be a wireless air interface based on a next generation mobile communication network technology standard of the 5G.

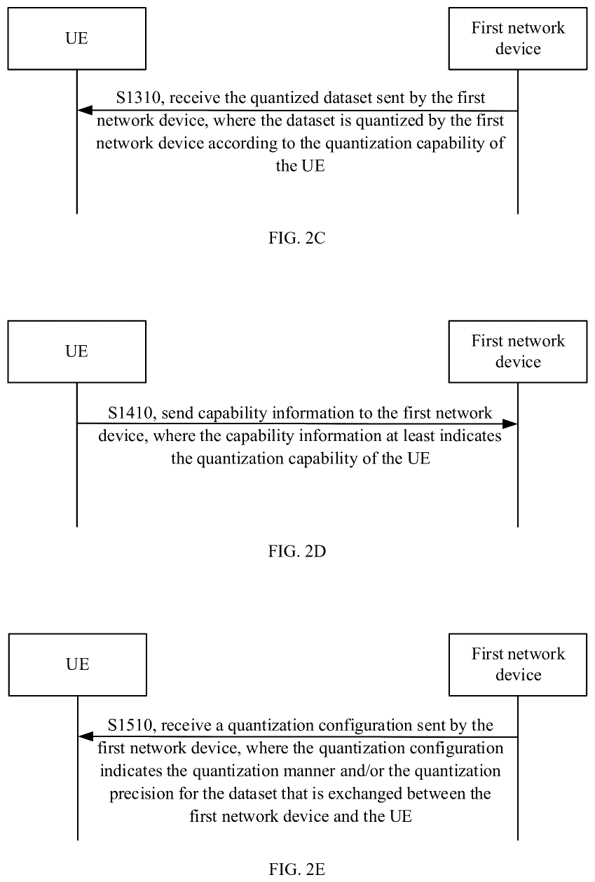

As shown in FIG. 2A, an embodiment of the present disclosure provides an information processing method. The method is performed by UE and includes the following step S1110.

At step S1110, a quantized dataset is exchanged with a first network device, where the dataset is quantized based on a quantization capability of the UE, and the dataset is configured for training, optimization, and/or supervision of an artificial intelligence (AI) model.

The UE may be the UE 11 shown in FIG. 1.

The UE may be various types of terminal devices or server devices connected to terminals. For example, the terminal device may include a fixed terminal and/or a mobile terminal. The mobile terminal may include a mobile phone, a tablet computer, a wearable device, a smart home device, a smart office device, and/or a vehicle-mounted device, etc. Specific model training, optimization, and/or supervision may be performed locally on the terminal device, or may be performed on a server associated with the terminal device.

Different UE has different quantization capabilities.

In the embodiment of the present disclosure, if the UE needs to exchange the dataset with the first network device, the UE exchanges the quantized dataset with the first network device according to the quantization capability of the UE. “Exchanging” in S1110 refers to “transmission”, which may include sending and/or receiving. For example, exchanging the quantized dataset with the first network device includes: sending, by the UE, the quantized dataset to the first network device; and/or receiving, by the UE, the quantized dataset sent by the first network device.

The dataset is configured for training, optimization, and/or supervision of the AI model.

The AI model may include various neural networks, etc. After the AI model is trained completely, the AI model may be used for compression of channel state information (CSI), etc. Certainly, this is merely an example of the AI model.

If the AI model is used for the compression of the channel state information, the dataset may include at least original channel state information. For example, original data obtained by the UE measuring a channel state information-reference signal (CSI-RS) is pre-processed to form the dataset.

The dataset may include a channel matrix and/or an eigenvector, etc.

For example, the dataset may be an eigenvector obtained by performing singular value decomposition (SDV) on the channel matrix. For example, the singular value decomposition is performed on a channel matrix of a 32*4 antenna port to obtain a 32*1 eigenvector, where there may be one or more eigenvectors. Of course, the above is only an example of the dataset, and the specific implementation process is not limited to the above example.

For example, the training of the AI model may be supervised-training by using sample data and labels of the sample data. For another example, the training of the AI model may also be unsupervised-training without the labels.

The optimization of the AI model may also be referred to as optimizing or fine-tuning of the AI model, that is, completing the initial training of the AI model. Considering special requirements of different application scenarios or special requirements of different time periods, a small amount of data training is further performed on the AI model that has been launched into the application or is to be launched into the application, that is, the optimization of the AI model.

The supervision of the AI model may include: supervision in training and/or application of the AI model.

In the embodiments of the present disclosure, the quantization capability of the UE may be measured in a plurality of dimensions, for example, a quantization manner supported by the UE, a quantization precision supported by the UE, and/or a quantization data volume supported by the UE disposable, etc. Of course, the above is merely an example, and the specific implementation is not limited to this example.

According to the quantization capability of the UE and the quantized dataset exchanged between the UE and the first network device, on one hand, the quantization capability of the UE may be fully utilized, and on the other hand, the problem that the UE cannot process the data after receiving the data due to quantization not supported by the UE, etc., may be reduced, so that a transmission success rate of the quantized dataset is improved.

As shown in FIG. 2B, an embodiment of the present disclosure provides an information processing method. The method is performed by UE and includes the following step S1210.

At step S1210, according to the quantization capability of the UE, the quantized dataset is sent to the first network device.

In this embodiment of the present disclosure, the UE quantizes the dataset according to the quantization capability of the UE, and then sends the quantized dataset to the first network device.

As shown in FIG. 2C, an embodiment of the present disclosure provides an information processing method. The method is performed by UE and includes the following step S1310.

At step S1310, the quantized dataset sent by the first network device is received, where the dataset is quantized by the first network device according to the quantization capability of the UE.

In this embodiment of the present disclosure, before the first network device sends the dataset, the first network device needs to firstly quantize the dataset, and then sends the quantized dataset to the UE. For example, the first network device quantifies the dataset according to the quantization capability of the UE. In this way, after the UE receives the dataset quantized by the first network device, the UE can relatively accurately restore the original dataset. For example, for different quantization capabilities of the UE, the first network device quantizes the dataset by using different quantization parameters. The quantization parameter includes a quantization manner and/or a quantization precision. For example, different quantization manners have different situations to save overheads. If the UE supports a quantization manner with a small signaling overhead, the quantization manner with the small signaling overhead is preferentially selected to quantize the dataset. Further, certainly, in a case where there is a quality requirement for quantization of the dataset, the quantization manner with the small signaling overhead is preferentially selected according to the quantization capability of the UE in the case that the quality requirement is met. For another example, if the quantization precision is taken as a measurement index, a quantization parameter with a maximum quantization precision is preferentially selected according to the quantization precision supported by the UE to quantize the dataset.

When quantizing the dataset, the first network device and/or the UE may actually select, according to a quantization requirement and a quantization capability of the UE, a quantization parameter that is suitable for the current scenario, to implement accurate data quantization and/or reduce the signaling overhead of the quantized dataset.

As shown in FIG. 2D, an embodiment of the present disclosure provides an information processing method. The method is performed by UE and includes the following step S1410.

At step S1410, capability information is sent to the first network device, where the capability information at least indicates the quantization capability of the UE.

In this embodiment of the present disclosure, the UE sends the capability information to the first network device, where the capability information may at least indicate a quantization capability of the UE, so that when the UE needs to exchange the quantized dataset with the first network device subsequently, the first network device facilitates performing operations according to the quantization capability of the UE.

It should be noted that the information processing method provided in this embodiment may be performed separately, or may be implemented in combination with any of the foregoing embodiments, for example, may be implemented in combination with the information processing method shown in FIG. 2A to FIG. 2C. For example, the UE sends the capability information to the first network device, and the first network device may send the quantized dataset to the UE according to the quantization capability of the UE.

In some embodiments, the capability information includes at least one of:
first information, indicating a quantization manner supported by the UE for the dataset; or
second information, indicating a quantization precision supported by the UE.

For different quantization manners, quantization logics or quantization tools are different. For example, the quantization manner is scalar quantization. Data exceeding a quantization unit may be directly intercepted according to the quantization unit, to implement quantization of data elements in the dataset. Of course, the above is merely an example. For example, the quantization unit is N bits after a decimal point, the decimal point data that exceeds the N bits is a data value that exceeds the quantization unit and that is intercepted through quantization.

The first information may be a manner identifier of a quantization manner and/or an indication bit that has a mapping relationship with the quantization manner.

The second information may be a precision value of the quantization precision or a serial number of the quantization precision, and is used to determine any information of the quantization precision.

The higher the quantization precision is, and the higher the similarity between the quantized dataset and the original dataset is; and the lower the quantization precision is, and the lower the similarity between the quantized dataset and the original dataset is.

In some embodiments, different quantization manners supported by the UE may implement different quantization precisions.

In some embodiments, the quantization manner includes at least one of:
scalar quantization; or
codebook quantization.

The scalar quantization may not involve vectors, but is used for quantization of data elements within a dataset without directions. The quantization of the data element in the dataset by the scalar quantization may include: quantizing a data element in a to-be-quantized dataset into a floating-point number with a preset precision.

The codebook quantization is a quantization manner in which data elements in a dataset need to be quantized by means of a codebook.

The codebook may be agreed on in advance by a protocol, or exchanged by the UE with the first network device in advance.

For example, the codebook may be a matrix including a plurality of codewords.

In some embodiments, one or more codebooks may include: a type 1 of codebook, a type 2 of codebook, and/or an enhancement type of codebook 2. The type 1 of codebook, the type 2 of codebook, and/or the enhancement type of codebook 2 may refer to related technologies, which will be not repeated herein.

In some embodiments, the second information includes at least one of:
a quantization order of scalar quantization;
a codebook type of codebook quantization, where quantization codebooks of different types correspond to different quantization precisions; or
a quantization factor of codebook quantization; where quantization factors of different types and/or different numbers correspond to different quantization precisions.

For example, when the scalar quantization, data elements in the dataset are quantized into floating-point numbers, and if the UE supports 16-bit floating-point numbers, 32-bit floating-point numbers, or 8-bit floating-point numbers, quantization orders are different. The higher the quantization order is, the smaller the difference between the quantized data element and the to-be-quantized data element is, and the higher the precision is.

For example, if the number of codewords included in the codebook and/or the number of elements included in a single codeword are different, the quantization precisions are different. For example, the number of codewords included in the codebook and/or the number of data elements included in a single codeword are positively correlated with the quantization precisions.

For example, it is assumed that the codebook includes 4 columns, that is, 4 column codewords, A1, A2, A3, and A4, or three rows, that is, 3 row codewords, B1, B2, and B3. If the to-be-quantized dataset is also a matrix of 4*3, according to the to-be-quantized matrix, the quantized matrix may be 1/2*A1, 2*A2 , 0*A3, and 3/2*A4. When the quantized dataset is transmitted, the quantization coefficient 1/2 and the identifier of the codeword A1, the quantization coefficient 2 and the identifier of the codeword A2, the quantization coefficient 0 and the identifier of the codeword A3, and the quantization coefficient 3/2 and the identifier of the codeword A4 are sent. Of course, this is merely an example of the codebook quantization.

In some embodiments, the capability information may be AI capability information, and the AI capability information indicates an AI capability of the UE. The foregoing quantization capability is one of AI capabilities. For example, the AI capability may further include a capability of an AI model supported by the UE and a model training type supported by the UE. For example, whether the UE supports jointly training the AI model with the network device may be indicated by the AI capability information.

The quantization factor is a factor used in the codebook quantization. For example, n quantization factors and at least one codebook are used to indicate one data row, and the larger n is, and the smaller a difference between the data row before the quantization and the data row after the quantization is. Therefore, the larger the number of n is, and the higher the corresponding quantization precision is. Here, n may be any one positive integer.

For example, Y=AX+B; Y may be data in the dataset before the quantization; X is a codeword in the codebook; A and B are quantization factors used in the quantization; obviously, A is a weighting factor in the quantization and B is an addition-subtraction factor used in the quantization. Therefore, the weighting factor and the addition-subtraction factor are different types of factors.

In some embodiments, the quantization factor may further include an exponent factor or a division factor, etc. It should be noted that the quantization factor is described only by the example herein, and specific implementation is not limited to this example.

As shown in FIG. 2E, an embodiment of the present disclosure provides an information processing method. The method is performed by UE and includes the following step S1510.

At step S1510, a quantization configuration sent by the first network device is received, where the quantization configuration indicates the quantization manner and/or the quantization precision for the dataset that is exchanged between the first network device and the UE.

The first network device may be an access device, for example, the access device may include the access device shown in FIG. 1.

Before transmitting the quantized dataset to the UE, the first network device may perform a quantization configuration according to the capability information reported by the UE.

The quantization configuration may be sent to the UE through higher layer signaling. For example, the UE receives a radio resource control (RRC) message and/or a medium access control (MAC) layer message, etc., that carry the quantization configuration.

Exemplary, the quantization configuration may include at least one of:
indication information of the quantization manner; or
indication information of the quantization precision.

For example, if the quantization configuration includes only the indication information of the quantization manner, it indicates that the first network device requires only the quantization manner, and the quantization precision may be based on a default precision or a highest quantization precision or a lowest quantization precision supported by the UE.

For another example, if the quantization configuration includes only the indication information of the quantization precision, it indicates that the first network device requires only the quantization precision, and the quantization manner may be performed in a default quantization manner or a common quantization manner.

For another example, if the quantization configuration includes both the indication information of the quantization manner and the indication information of the quantization precision, the quantization manner and the quantization precision may be directly determined according to the quantization configuration when the quantized dataset is exchanged.

Certainly, the foregoing is merely an example of the quantization configuration sent by the first network device, and the specific implementation is not limited to the foregoing example.

In some other embodiments, the first network device may send the quantization configuration with the higher layer signaling, and if there are a plurality of sets of quantization configurations, the first network device may schedule one set of quantization configurations from the plurality of sets of quantization configurations to use by a physical layer instruction before the specifically quantized dataset is exchanged.

In some other embodiments, the first network device may send the quantization configuration with the higher layer signaling, and if there are a plurality of sets of quantization configurations, the first network device may activate one set of quantization configurations from the plurality of sets of quantization configurations to use by an MAC layer instruction before the specifically quantized dataset is exchanged. In some other embodiments, the first network device may send the quantization configuration with RRC signaling, and if there are a plurality of sets of quantization configurations, the first network device may activate one or more sets of quantization configurations by a MAC, where the activated quantization configurations are standby quantization configurations. The final used quantization configuration is determined from the activated quantization configurations upon receiving downlink control information (DCI).

As shown in FIG. 2F, an embodiment of the present disclosure provides an information processing method. The method is performed by UE and includes the following step S1610.

At step S1610, a quantization parameter is sent to the first network device, where the quantization parameter indicates the quantization manner and/or the quantization precision for the dataset that is exchanged between the first network device and the UE.

In some cases, the UE may not in advance exchange the capability information of the UE with the first network device, or the first network device does not in advance send the quantization configuration. Before the UE exchanges the quantized dataset with the first network device, the UE exchanges the quantization parameter with the first network device, or the UE exchanges the quantization parameter with the first network device along with the quantized dataset. For example, the UE notifies, by sending the quantization parameter to the first network device, the first network device of the quantization manner and/or quantization precision for the UE sending the quantized dataset. Alternatively, the UE notifies, by sending the quantization parameter to the first network device, that the UE wants to receive the quantized dataset using what quantization parameters.

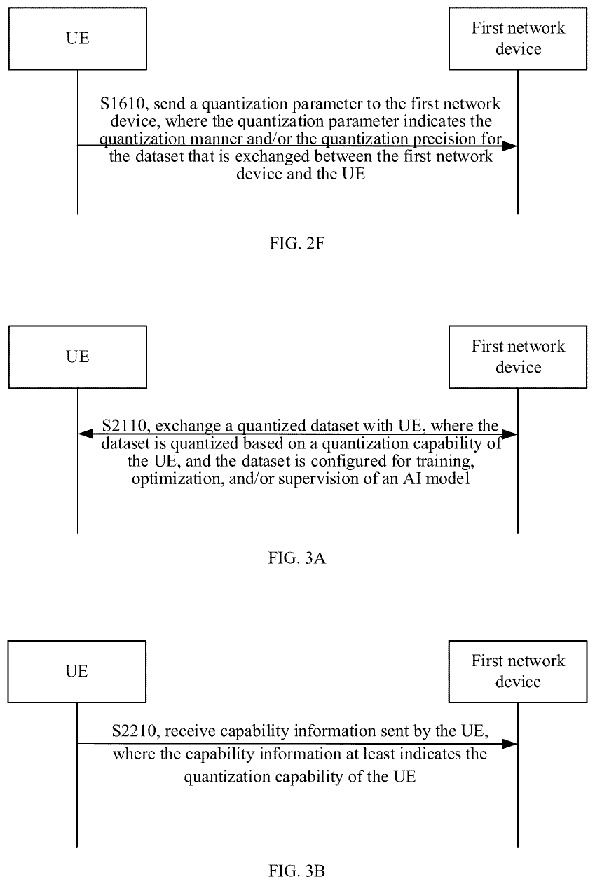

As shown in FIG. 3A, an embodiment of the present disclosure provides an information processing method. The method is performed by a first network device and includes the following step S2110.

At step S2110, a quantized dataset is exchanged with user equipment (UE), where the dataset is quantized based on a quantization capability of the UE, and the dataset is configured for training, optimization, and/or supervision of an artificial intelligence (AI) model.

The dataset is configured for training, optimization, and/or supervision of the AI model.

The first network device may be an access device and/or a core network device.

In some embodiments, the information processing method may include:
determining a quantization capability of the UE; and
quantizing the dataset according to the quantization capability of the UE.

Exemplary, determining the quantization capability of the UE may include at least one of:
determining the quantization capability of the UE according to the capability information of the UE;
determining the quantization capability of the UE according to the type of the UE; or
determining the quantization capability of the UE according to subscription data of the UE.

The quantization capability of the UE is determined according to the subscription status of the UE for the predetermined service, and different services have different requirements on the capability of the UE, so the quantization capability of the UE may be reversed according to whether the predetermined service is subscribed and/or the service type of the predetermined service.

In conclusion, there are many manners in which the first network device determines the quantization capability of the UE, and the specific implementation is not limited to any one of the foregoing.

After the quantization capability of the UE is determined, the quantized dataset is sent to the UE according to the quantization capability of the UE, and/or the quantized dataset sent by the UE is received according to the quantization capability of the UE.

According to the quantization capability of the UE and the quantized dataset exchanged between the first network device and the UE, on one hand, the quantization capability of the UE may be fully utilized, and on the other hand, the problem that the UE cannot process the data after receiving the data due to quantization not supported by the UE, etc., may be reduced, so that a transmission success rate of the quantized dataset is improved.

In some embodiments, determining the quantization capability of the UE includes:
determining a quantization manner and/or a quantization precision supported by the UE.

For different quantization manners, quantization logics or quantization tools are different. For example, the quantization manner is scalar quantization. Data exceeding a quantization unit may be directly intercepted according to the quantization unit, to implement quantization of data elements in the dataset. Of course, the above is merely an example. For example, the quantization unit is N bits after a decimal point, the decimal point data that exceeds the N bits is a data value that exceeds the quantization unit and that is intercepted through quantization.

In some embodiments, the information processing method may include:
receiving the quantized dataset sent by the UE. The dataset is quantized according to the quantization capability of the UE.

In some embodiments, the first network device restores the dataset quantized by the UE according to the quantization parameter used by the UE. The quantization parameter is determined according to a capability of the UE, or the quantization parameter is determined according to a quantization configuration, where the quantization configuration is determined by the first network device according to the quantization capability of the UE.

As shown in FIG. 3B, an embodiment of the present disclosure provides an information processing method. The method is performed by a first network device and includes the following step S2210.

At step S2210, capability information sent by the UE is received, where the capability information at least indicates the quantization capability of the UE.

The dataset is configured for training, optimization, and/or supervision of the AI model.

The first network device first receives the capability information sent by the UE. The capability information may be quantization capability information merely indicating a quantization capability of the UE, or may be AI capability information indicating an AI capability of the UE. The AI capability information includes the quantization capability information. Certainly, it should be noted that the capability information may include information such as a quantization capability and/or a communication capability of the UE, etc.

For example, the UE sends the capability information of the UE to the network device, during the UE registers with the network or the UE accesses the network.

When the capability information sent by the UE is received, the quantized dataset is sent to the UE according to the capability information of the UE, and/or the quantized dataset sent by the UE is received. Therefore, on one hand, the quantization capability of the UE may be fully utilized, and on the other hand, the problem that the UE cannot process the data after receiving the data due to quantization not supported by the UE, etc., may be reduced, so that a transmission success rate of the quantized dataset is improved.

The first information may be a manner identifier of a quantization manner and/or an indication bit that has a mapping relationship with the quantization manner.

The second information may be a precision value of the quantization precision or a serial number of the quantization precision, and is used to determine any information of the quantization precision.

The higher the quantization precision is, and the higher the similarity between the quantized dataset and the original dataset is; and the lower the quantization precision is, and the lower the similarity between the quantized dataset and the original dataset is.

In some embodiments, different quantization manners supported by the UE may implement different quantization precisions.

In some embodiments, the quantization manner includes at least one of:
scalar quantization; or
codebook quantization.

The scalar quantization may not involve vectors, but is used for quantization of data elements within a dataset without directions. The quantization of the data element in the dataset by the scalar quantization may include: quantizing a data element in a to-be-quantized dataset into a floating-point number with a preset precision.

The codebook quantization is a quantization manner in which data elements in a dataset need to be quantized by means of a codebook.

The codebook may be agreed on in advance by a protocol, or exchanged by the UE with the first network device in advance.

For example, the codebook may be a matrix including a plurality of codewords.

In some embodiments, one or more codebooks may include: a type 1 of codebook, a type 2 of codebook, and/or an enhancement type of codebook 2. The type 1 of codebook, the type 2 of codebook, and/or the enhancement type of codebook 2 may refer to related technologies, which will be not repeated herein.

In some embodiments, the second information includes at least one of:
a quantization order of scalar quantization;
a codebook type of codebook quantization, where quantization codebooks of different types correspond to different quantization precisions; or
a quantization factor of codebook quantization; where quantization factors of different types and/or quantization factors of different numbers correspond to different quantization precisions.

For example, when the scalar quantization, data elements in the dataset are quantized into floating-point numbers, and if the UE supports 16-bit floating-point numbers, 32-bit floating-point numbers, or 8-bit floating-point numbers, quantization orders are different. The higher the quantization order is, the smaller the difference between the quantized data element and the to-be-quantized data element is, and the higher the precision is.

In some embodiments, when the codebook quantization is used, data elements, vectors, data rows, or data columns in the quantized dataset may be expressed in combination with one or more codewords in the codebook.

The quantization factor is a factor used in the codebook quantization. For example, n quantization factors and at least one codebook are used to indicate one data row, and the larger n is, and the smaller a difference between the data row before the quantization and the data row after the quantization is. Therefore, the larger the number of n is, and the higher the corresponding quantization precision is. Here, n may be any one positive integer.

For example, Y=AX+B; Y may be data in the dataset before the quantization; X is a codeword in the codebook; A and B are quantization factors used in the quantization; obviously, A is a weighting factor in the quantization and B is an addition-subtraction factor used in the quantization. Therefore, the weighting factor and the addition-subtraction factor are different types of factors.

In some embodiments, the quantization factor may further include an exponent factor or a division factor, etc.

As shown in FIG. 3C, an embodiment of the present disclosure provides an information processing method. The method is performed by a first network device and includes the following steps S2310-S2320.

At step S2310, a predefined quantization capability associated with the UE is obtained.

At step S2320, the quantized dataset is exchanged with the UE according to the quantization capability of the UE.

The dataset is configured for training, optimization, and/or supervision of the AI model.

In the embodiment of the present disclosure, obtaining the predefined quantization capability associated with the UE may include at least one of:
obtaining, according to a type of the UE, a quantization capability associated with the type of UE, and/or querying, from another network device, a quantization capability subscribed by the UE.

For example, the obtaining a predefined quantization manner and/or quantization precision associated with the UE, includes at least one of:
querying the predefined quantization capability subscribed by the UE from a second network device; or
determining, according to a protocol agreement, the predefined quantization capability supported by the UE.

For example, the second network device may be a user data management (UDM) device and/or a unified data repository (UDR) device. The first network device may send a query request to the second network device, where the query request may include the identifier of the UE, to query the quantization capability supported by the UE.

For another example, the protocol agrees on a quantization capability of the UE that supports AI model training. Alternatively, if the protocol agrees on the type of the AI model training supported by the UE, the UE is required to have a corresponding quantization capability, so that the quantization capability supported by the UE can be determined according to AI model training, optimization, or supervised request scheduling requested by the UE.

In some embodiments, there are a plurality of manners in which the first network device obtains the quantization capability of the UE, and there may be no certain priority between the manners each other.

Therefore, the first network device obtains, according to a requirement of the first network device and/or obtaining convenience, information related to the quantization capability of the UE.

In some embodiments, obtaining the predefined quantization capability associated with the UE, includes:
obtaining, in a case where the capability information sent by the UE is not received, the predefined quantization capability associated with the UE.

In the embodiment of the present disclosure, not receiving the capability information of the UE may include but is not limited to: not reporting, by the UE, the capability information, and/or having reported, by the UE, the capability information but failing to receive it.

That is, in the case that the capability information sent by the UE is successfully received, the quantization capability of the UE is determined according to the capability information reported by the UE itself; otherwise, the quantization capability of the UE may be determined by querying the predefined quantization capability subscribed by the UE from the second network device, or the quantization capability of the UE may be determined according to a protocol agreement.

As shown in FIG. 3D, an embodiment of the present disclosure provides an information processing method. The method is performed by a first network device and includes the following step S2710.

At step S2710, according to the quantization capability of the UE, the quantized dataset is sent to the UE.

In this embodiment, the quantized dataset is sent to the UE according to the quantization capability of the UE, so that the datasets that the UE cannot correctly obtain due to exceeding the quantization capability of the UE are reduced.

As shown in FIG. 3E, an embodiment of the present disclosure provides an information processing method. The method is performed by a first network device and includes the following step S2410.

At step S2410, the quantized dataset sent by the UE based on the quantization capability of the UE is received.

In the embodiment of the present disclosure, the quantized dataset received by the first network device is a dataset quantized by the UE according to its own quantization capability.

As shown in FIG. 3F, an embodiment of the present disclosure provides an information processing method. The method is performed by a first network device and includes the following step S2510.

At step S2510, according to the quantization capability of the UE, a quantization configuration is sent to the UE, where the quantization configuration indicates the quantization manner and/or the quantization precision for the dataset that is exchanged between the first network device and the UE.

Before sending the quantized dataset to the UE and/or receiving the quantized dataset sent by the UE, the quantization configuration is sent to the UE according to the quantization capability of the UE. If the quantized dataset is sent to the UE, the UE may subsequently process the quantized dataset according to the quantization configuration. If the quantized dataset of the UE is received, the UE quantizes data elements in the dataset according to the quantization configuration.

As shown in FIG. 3G, an embodiment of the present disclosure provides an information processing method. The method is performed by a first network device and includes the following step S2610.

At step S2610, a quantization parameter sent by the UE is received, where the quantization parameter indicates the quantization manner and/or the quantization precision for the dataset that is exchanged between the first network device and the UE.

For example, the UE sends the quantized dataset to the first network device, quantization of the quantized dataset is performed by using the quantization parameter, and the quantization parameter may be sent to the first network device together with the quantized dataset.

For another example, when the first network device needs to send the quantized dataset to the UE, the UE may notify, by using the quantization parameter, the first network device of what quantized dataset is needed, or may use the quantization parameter to indicate the quantized dataset.

In some other embodiments, the quantization manner includes at least one of:
scalar quantization; or
codebook quantization.

For different quantization manners, quantization logics or quantization tools are different. For example, the quantization manner is scalar quantization. Data exceeding a quantization unit may be directly intercepted according to the quantization unit, to implement quantization of data elements in the dataset. Of course, the above is merely an example. For example, the quantization unit is N bits after a decimal point, the decimal point data that exceeds the N bits is a data value that exceeds the quantization unit and that is intercepted through quantization.

The UE reports the situation of supporting the representation/quantization form of the dataset.

As UE capability reporting, the UE supports at least one of the following representation/quantization forms of the dataset:
scalar quantization, such as floating-point number 16 (or float 16) or floating-point number 32 (or float 32); or
high-precision codebook quantization, for example, high-precision codebook quantization 1 and high-precision codebook quantization 2 based on an enhancement type (eType) II of codebook.

The foregoing capability may be reported as a separate capability, or may be included in another capability to be reported.

For example, the AI CSI capability 1 indicates that the high-precision codebook quantization 1 and the training manner 1 may be supported.

When the UE exchanges a dataset with a network (NW), the UE reports, indicates, or configures information associated with a representation/quantization form of the exchanged dataset. The NW herein represents a network device.

In some embodiments, a scenario where the UE sends a dataset to the NW is as follows.

Example 1: The NW decides the quantization form of the dataset, and the UE reports the dataset to the NW based on a configuration of the NW. The NW configures or indicates the quantization form of the dataset through the first signaling and/or the third signaling.

Based on the quantization capability configuration reported by the UE, particularly, when the UE supports higher order quantization such as float 32, the NW may configure quantization as float 16 to reduce signaling overhead when transmitting the dataset.

In the case that there is no UE quantization capability reporting, the configuration is performed based on a predefined quantization manner.

Example 2: The UE decides the quantization form of the dataset, the UE voluntarily decides the quantization form according to a characteristic of the dataset, and the UE notifies the NW of the quantization form of the dataset through the second signaling.

A scenario where the NW sends a dataset to the UE is as follows.

### Example 1

The NW decides the quantization form of the dataset. The NW configures or indicates the quantization form of the dataset through the first signaling and/or the third signaling.

The NW determines the quantization form of the to-be-transmitted dataset according to the quantization capability reported by the UE.

In the case that there is no UE quantization capability reporting, the configuration is performed based on a predefined quantization manner.

The first signaling may be RRC signaling, the second signaling may be UCI or a MAC CE, and the third signaling may be DCI or an MAC CE.

The dataset includes at least original CSI.

The exchange of the above dataset is used at least for one of model training, model performance supervision, and model fine-tuning.

### Example 3

The quantization capability reported by the UE is high precision codebook quantization 2.

The quantization manner of the NW configuring the original CSI in the RRC signaling, such as CSI report configuration, is the high-precision codebook quantization 2.

When the original CSI is exchanged between the NW and the UE during AI model training, optimization (fine-tuning), and supervision, the original CSI that may be decoded and transferred between the UE and the NW is quantized by the high-precision codebook quantization 2.

### Example 4

The quantization capability reported by the UE is float 32 and the high precision codebook quantization 1.

The quantization manner of the NW configuring the original CSI config #1 in the RRC signaling, such as CSI report configuration, is the high-precision codebook quantization 1.

A quantization manner of the original CSI config #2 is float 32.

A manner in which the NW uses the MAC CE to indicate transmission of at least one piece of original CSI is the original CSI config #1.

When the original CSI is exchanged between the NW and the UE during AI model training, fine-tuning, and/or supervision, the UE and the NW may understand that the transmitted original CSI is quantized by the high-precision codebook quantization 1.

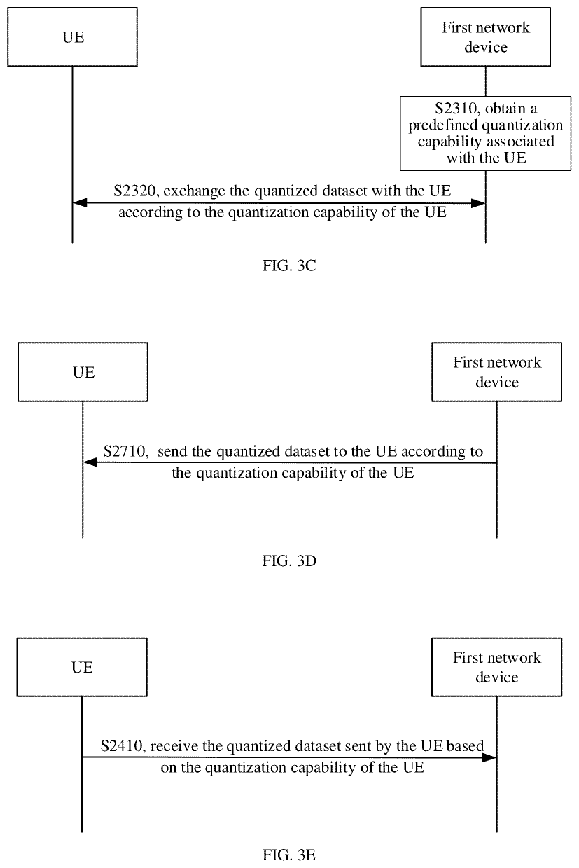

As shown in FIG. 4, an embodiment of the present disclosure provides an information processing apparatus. The apparatus includes:
a transmission module 110, configured to exchange a quantized dataset with a first network device, where the dataset is quantized based on a quantization capability of UE, and the dataset is configured for training, optimization, and/or supervision of an AI model.

The information processing apparatus may be included in the UE.

In some embodiments, the transmission module 110 may be a program module, and after the program module is executed by the processor, the above operations can be implemented.

In some embodiments, the transmission module 110 may be a software and hardware combination module, and the software and hardware combination module includes but is not limited to programmable arrays. The programmable arrays include but are not limited to field programmable arrays and/or complex programmable arrays.

In some other embodiments, the transmission module 110 may be a hardware-only module; and the hardware-only module includes but is not limited to an application specific integrated circuit.

In some other embodiments, the transmission module 110 is configured to send the quantized dataset to the first network device according to the quantization capability of the UE; or receive the quantized dataset sent by the first network device, where the dataset is quantized by the first network device according to the quantization capability of the UE.

In some embodiments, the transmission module 110 includes:
a sending unit, configured to send capability information to the first network device, where the capability information at least indicates the quantization capability of the UE.

The sending unit may be a sending antenna and/or a sending interface, etc.

In some embodiments, the capability information includes at least one of:
first information, indicating a quantization manner supported by the UE for the dataset; or
second information, indicating a quantization precision supported by the UE.

In some embodiments, the quantization manner includes at least one of:
scalar quantization; or
codebook quantization.

In some embodiments, the second information includes at least one of:
a quantization order of scalar quantization;
a codebook type of codebook quantization, where quantization codebooks of different types correspond to different quantization precisions; or
a quantization factor of codebook quantization; where quantization factors of different types and/or quantization factors of different numbers correspond to different quantization precisions.

In some embodiments, the transmission module 110 further includes:
a receiving unit, configured to receive a quantization configuration sent by the first network device, where the quantization configuration indicates the quantization manner and/or the quantization precision for the dataset that is exchanged between the first network device and the UE.

The receiving unit may be a receiving antenna and/or a receiving interface, etc.

In some embodiments, the transmission module 110 further includes:
a sending unit, configured to send a quantization parameter to the first network device, where the quantization parameter indicates the quantization manner and/or the quantization precision for the dataset that is exchanged between the first network device and the UE.

The sending unit may be a sending antenna and/or a sending interface, etc.

In some embodiments, the apparatus further includes a storage module, and the storage module may be configured to store the quantized dataset.

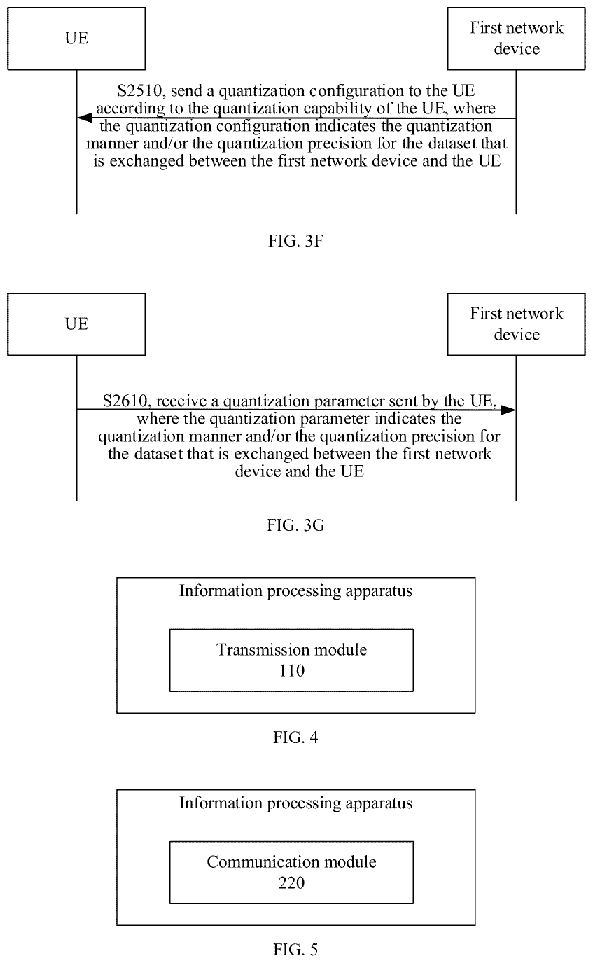

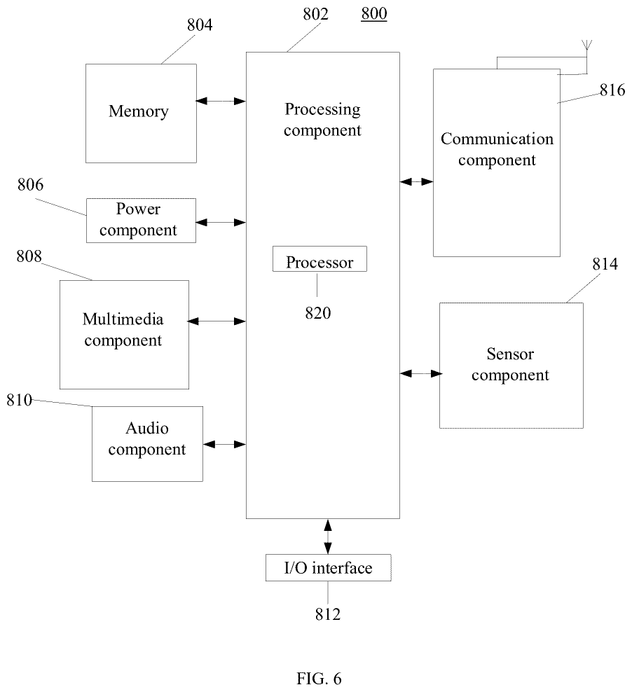

As shown in FIG. 5, an embodiment of the present disclosure provides an information processing apparatus. The apparatus includes:
a communication module 220, configured to exchange a quantized dataset with UE, where the dataset is quantized based on a quantization capability of the UE, and the dataset is configured for training, optimization, and/or supervision of an AI model.

The information processing apparatus may be included in a first network device.

In some embodiments, the communication module 220 may be a program module, and after the program module is executed by the processor, the above operations can be implemented.

In some embodiments, the communication module 220 may be a software and hardware combination module, and the software and hardware combination module includes but is not limited to programmable arrays. The programmable arrays include but are not limited to field programmable arrays and/or complex programmable arrays.

In some other embodiments, the communication module 220 may be a hardware-only module; and the hardware-only module includes but is not limited to an application specific integrated circuit.

In some embodiments, the apparatus further includes:
a determination module, configured to determine a quantization capability of the UE, where the quantization capability of the UE includes a quantization manner and/or a quantization precision supported by the UE.

In some embodiments, the determination module is configured to receive capability information sent by the UE, where the capability information at least indicates the quantization capability of the UE; or obtain a predefined quantization capability associated with the UE.

In some embodiments, the determination module is configured to perform at least one of: querying the predefined quantization capability subscribed by the UE from a second network device; or determining, according to a protocol agreement, the predefined quantization capability supported by the UE.

In some embodiments, the determination module is configured to obtain, in a case where the capability information sent by the UE is not received, the predefined quantization capability associated with the UE.

In some embodiments, the communication module 220 is configured to send, according to the quantization capability of the UE, the quantized dataset to the UE; and/or, receive the quantized dataset sent by the UE based on the quantization capability of the UE.

In some embodiments, the communication module 220 is further configured to send, according to the quantization capability of the UE, a quantization configuration to the UE, where the quantization configuration indicates the quantization manner and/or the quantization precision for the dataset that is exchanged between the first network device and the UE.

In some embodiments, the communication module 220 is configured to receive a quantization parameter sent by the UE, where the quantization parameter indicates the quantization manner and/or the quantization precision for the dataset that is exchanged between the first network device and the UE.

In some embodiments, the quantization manner includes at least one of: scalar quantization; or codebook quantization.

In some embodiments, the capability information includes at least one of:
first information, indicating a quantization manner supported by the UE for the dataset; or
second information, indicating a quantization precision supported by the UE.

In some embodiments, the second information includes at least one of:
a quantization order of scalar quantization;
a codebook type of codebook quantization, where quantization codebooks of different types correspond to different quantization precisions; or
a quantization factor of codebook quantization; where quantization factors of different types and/or different numbers correspond to different quantization precisions.

An embodiment of the present disclosure provides a communication device, including:
a memory configured to store instructions executable by a processor;
the processor connected to the memory;
where the processor is configured to perform the information processing method provided in any of the above technical solutions.

The processor may include various types of storage mediums. The storage mediums are non-transitory computer storage mediums, and can continue to memorize information stored in the storage mediums after the communication device is powered off.

Here, the communication device includes the UE or the network device.

The processor may be connected to the memory by a bus or the like, and is configured to read an executable program stored in the memory, to implement for example, at least one of the methods shown in FIG. 2A to FIG. 2F or FIG. 3A to FIG. 3G.

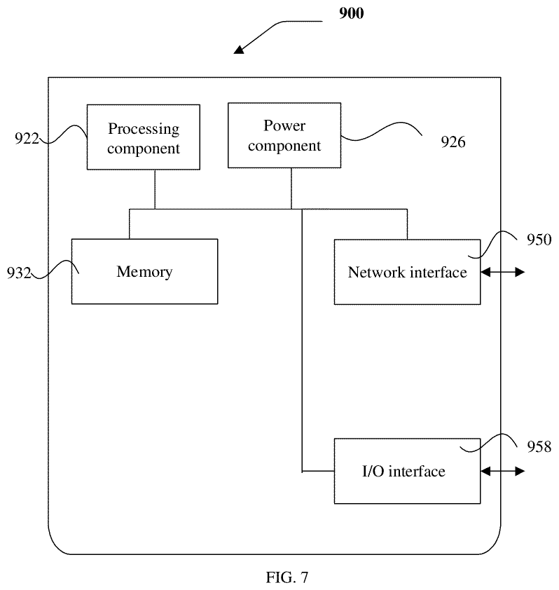

FIG. 7 is a block diagram of UE 800 shown according to an exemplary embodiment. For example, the UE 800 may be a mobile phone, a computer, a digital broadcast user equipment, a message transceiving device, a game console, a tablet device, a medical device, a fitness device, a personal digital assistant, etc.

Referring to FIG. 7, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the UE 800, such as operations associated with display, phone calls, data communication, camera operations, and recording operations. The processing component 802 may include one or more processors 820 to execute instructions to generate all or part of the steps in the above methods. Additionally, the processing component 802 may include one or more modules to facilitate exchanging between the processing component 802 and other components. For example, the processing component 802 may include a multimedia module to facilitate exchanging between the multimedia component 808 and the processing component 802.

The memory 804 is configured to store various types of data to support operations of the UE 800. Examples of such data include instructions, contact data, phonebook data, messages, pictures, videos, etc., for any application program or method operating on the UE 800. The memory 804 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the UE 800. The power component 806 may include a power supply management system, one or more power supplies, and other components that are associated with generating, managing, and distributing power for the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 808 includes a front facing camera and/or a rear facing camera. When the UE 800 is in an operation mode, such as a shooting mode or a video mode, the front facing camera and/or the rear facing camera can receive external multimedia data. Each of the front facing camera and rear facing camera may be a fixed optical lens system or has a focal length and an optical zoom capability.

The audio component 810 is configured to output and/or input audio signals. For example, the audio component 810 includes a microphone (MIC). The microphone is configured to receive external audio signals when the UE 800 is in the operating mode, such as a call mode, a recording mode, and a speech recognition mode. The received audio signals may be further stored in the memory 804 or sent via the communication component 816. In some embodiments, the audio component 810 also includes a speaker for outputting the audio signals.

The I/O interface 812 provides an interface between the processing component 802 and peripheral interface modules. The peripheral interface modules may be keyboards, click wheels, buttons, etc. These buttons may include but are not limited to: a home button, a volume button, a start button, and a lock button.

The sensor component 814 includes one or more sensors to provide various aspects of state assessment for the UE 800. For example, the sensor component 814 may detect an open/closed state of the UE 800, relative positioning of components that are for example a display and keypad of the UE 800. The sensor component 814 may also detect a position change of the UE 800 or of a component of the UE 800, presence or absence of the user contacting with the UE 800, an orientation or acceleration/deceleration of the UE 800, and a temperature change of the UE 800. The sensor component 814 may include a proximity sensor configured to detect the presence of nearby objects without any physical contact. The sensor component 814 may also include a light sensor, such as a CMOS or CCD image sensor, for use in an imaging application. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G, 3G, or a combination of them. In an exemplary embodiment, the communication component 816 receives, via a broadcast channel, a broadcast signal or broadcast related information from an external broadcast management system. In an exemplary embodiment, the communication component 816 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an exemplary embodiment, a non-transitory computer-readable storage medium including instructions is also provided, such as the memory 804 including the instructions. The above instructions may be executed by the processor 820 of the UE 800 to generate the above methods. For example, the non-transitory computer-readable storage medium may be a ROM, a random access memory (RAM), a CD-ROM, a magnetic tape, a floppy disk, an optical data storage device, etc.

As shown in FIG. 7, an embodiment of the present disclosure shows a structure of a network device. Referring to FIG. 7, the network device 900 includes a processing component 922, that further includes one or more processors, and memory resources represented by a memory 932, for storing instructions that is executable by the processing component 922, such as an application program. The application program stored in the memory 932 may include one or more modules that each corresponds to a set of instructions. In addition, the processing component 922 is configured to execute instructions to perform any method applied to the access device in the above methods, for example, at least one of the methods shown in FIG. 2A to FIG. 2F or FIG. 3A to FIG. 3G.

The network device 900 may also include a power component 926 configured to perform power management of the network device 900, a wired or wireless network interface 950 configured to connect the network device 900 to the network, and an input/output (I/O) interface 958. The network device 900 may operate an operating system stored in the memory 932, such as Windows Server TM, Mac OS X™, Unix™, Linux™, FreeBSD™, or a similar operating system.

Those skilled in the art will easily come up with other implementation solutions of embodiments of the present disclosure after considering the specification and practicing the present disclosure disclosed herein. The present disclosure aims to cover any variations, uses, or adaptive changes of embodiments of the present disclosure, which follow general principles of the embodiments of the present disclosure and include common knowledge or customary technical means in the art not disclosed in the present disclosure. The specification and embodiments are only considered exemplary, and the true scope and spirit of embodiments of the present disclosure are indicated by the following claims.

It should be understood that embodiments of the present disclosure are not limited to the precise structure described above and shown in the accompanying drawings, and various modifications and changes may be made without departing from their scope. The scope of embodiments of the present disclosure is limited only by the appended claims.

1. An information processing method, performed by user equipment (UE) and comprising:
exchanging a quantized dataset with a first network device,
wherein the dataset is quantized based on a quantization capability of the UE, and
the dataset is configured for at least one of training, optimization, or supervision of an artificial intelligence (Al) model.

2. The method of claim 1, wherein the exchanging a quantized dataset with a first network device, comprises:
sending, according to the quantization capability of the UE, the quantized dataset to the first network device; or,
receiving the quantized dataset sent by the first network device, wherein the dataset is quantized by the first network device according to the quantization capability of the UE.

3. The method of claim 1, further comprising:
sending capability information to the first network device, wherein the capability information at least indicates the quantization capability of the UE.

4. The method of claim 3, wherein the capability information comprises at least one of:
first information, indicating a quantization manner supported by the UE ; or
second information, indicating a quantization precision supported by the UE.

5. The method of claim 4, wherein the quantization manner comprises at least one of:
scalar quantization; or
codebook quantization.

6. The method of claim 4, wherein the second information comprises at least one of:
a quantization order of scalar quantization;
a quantization codebook type of codebook quantization, wherein quantization codebooks of different types correspond to different quantization precisions; or
a quantization factor of codebook quantization; wherein quantization factors of at least one of different types or different numbers correspond to different quantization precisions.

7. The method claim 4, further comprising:
receiving a quantization configuration sent by the first network device, wherein the quantization configuration indicates at least one of the quantization manner or the quantization precision for the dataset that is exchanged between the first network device and the UE; or,
sending a quantization parameter to the first network device, wherein the quantization parameter indicates at least one of the quantization manner or the quantization precision for the dataset that is exchanged between the first network device and the UE.

8. An information processing method, performed by a first network device and comprising:
exchanging a quantized dataset with user equipment (UE),
wherein the dataset is quantized based on a quantization capability of the UE, and
the dataset is configured for at least one of training, optimization, or supervision of an artificial intelligence (Al) model.

9. The method of claim 8, further comprising:
determining the quantization capability supported by the UE, wherein the quantization capability of the UE comprises at least one of a quantization manner or a quantization precision supported by the UE.

10. The method of claim 8, wherein the determining the quantization capability supported by the UE, comprises:
receiving capability information sent by the UE, wherein the capability information at least indicates the quantization capability of the UE. or,
obtaining a predefined quantization capability associated with the UE.

11. The method of claim 10, wherein the obtaining a predefined quantization capability associated with the UE, comprises at least one of:
querying, from a second network device, the predefined quantization capability subscribed by the UE; or
determining, according to a protocol agreement, the predefined quantization capability supported by the UE.

12. The method of claim 10, wherein the obtaining a predefined quantization capability associated with the UE, comprises:
obtaining, in a case where the capability information sent by the UE is not received, the predefined quantization capability associated with the UE.

13. The method of claim 9, wherein the exchanging a quantized dataset with UE, comprises at least one of:
sending, according to the quantization capability of the UE, the quantized dataset to the UE; or
receiving the quantized dataset sent by the UE based on the quantization capability of the UE.

14. The method of claim 9, further comprising:
sending, according to the quantization capability of the UE, a quantization configuration to the UE, wherein the quantization configuration indicates at least one of the quantization manner or the quantization precision for the dataset that is exchanged between the first network device and the UE.

15. The method of claim 8, further comprising:
receiving a quantization parameter sent by the UE, wherein the quantization parameter indicates at least one of a quantization manner or a quantization precision for the dataset that is exchanged between the first network device and the UE.

16. The method of claim 9, wherein the quantization manner comprises at least one of:
scalar quantization; or
codebook quantization.

17.-20. (canceled)

21. A user equipment (UE), comprising:
a processor;
a transceiver; and
a memory storing a program executable by the processor,
wherein the processor is configured to:
exchange a quantized dataset with a first network device,
wherein the dataset is quantized based on a quantization capability of the UE, and
the dataset is configured for at least one of training, optimization, or supervision of an artificial intelligence (AI) model.

22. A non-transitory computer storage medium, storing an executable program, wherein when the executable program is executed by a processor, the processor is caused to perform the method of claim 1.

23. A network device, comprising:
a processor;
a transceiver; and
a memory storing a program executable by the processor,
wherein the processor is configured to perform the method of claim 8.

24. A non-transitory computer storage medium, storing an executable program, wherein when the executable program is executed by a processor, the processor is caused to perform the method of claim 8.
